(19) United States
(12) Patent Application Publication
(10) Pub. No.: US 2005/0002298 A1
(43) Pub. Date: Jan. 6, 2005

(54) System and method for discriminating recording area of optical storage medium

(75) Inventor: Kuen-Suey Hou, Hsin-Chu City (TW)

Correspondence Address: TROXELL LAW OFFICE PLLC, SUITE 1404, 5205 LEESBURG PIKE, FALLS CHURCH, VA, 22041, US

(73) Assignee: MediaTek Inc.

(21) Appl. No.: 10/670,228

(22) Filed: Sep. 26, 2003

(30) Foreign Application Priority Data
Jul. 1, 2003 (TW) 092118007

(51) Int. Cl. G11B 7/00

(52) U.S. Cl. 369/47.22; 369/53.22

(57) ABSTRACT

An optical discriminating system is for discriminating whether a reflected light beam is from headers of an optical storage medium. Each header comprises a first embossed position and a second embossed position for recording an address information. A light beam detecting module is for receiving the reflected light beam. When the reflected light beam is from the first or second embossed position, a first or second header signal is generated. When the reflected light beam comprises the address information, an address mark signal is generated. A signal detecting module is for receiving the first header signal, the second header signal, and the address mark signal. When continuously receiving the first and second header signals, and also the address mark signal at the same time, then the signal detecting module discriminates that the reflected light beam is from one of the headers.

### BACKGROUND OF THE INVENTION

1. Field of the Invention

The present invention relates to an optical discriminating system and method thereof, more particularly to an optical discriminating system applied in an optical reading/reproducing device for discriminating the headers of an optical storage medium.

2. Description of the Prior Art

Referring to FIG. 1, FIG. 1 is a schematic diagram of a track 10 of a conventional DVD-RAM (DVD-random access memory) disc. A conventional optical disc, such as a DVD-RAM disc comprises a plurality of tracks 10. These tracks 10 are divided into a plurality of sectors 14, and each sector 14 comprises a header 16 and a recording area 18. A plurality of recording pits 11, 12, and 13 spread over the tracks 10. The recording pits 11 and 12 of the header 16 are arranged along the upper and lower side of the track 10 for recording the address information of the sector 14. The pits 13 of the recording area 18 are in the middle of the track for recording contents of information.

In a conventional DVD-RAM reading/reproducing device, identifying the header correctly can lower the errors when reading or writing data by the optical reading/reproducing device. The prior art uses the header indication signal generated by extracting the low pass filtered RF subtraction (RFSUB) signal or the differential phase detection (DPD) signal to assist in identifying the header, so as to make the servo control and the RF circuit of the optical reading/reproducing device operate more reliably.

Referring to FIG. 1 and FIG. 2, FIG. 2 is a schematic diagram of the generating circuit of the header indication signal of a conventional DVD-RAM reading/reproducing device. In the prior art, a light beam is shot to the middle of track 10 for detecting the distribution of the recording pits and obtaining four signals A, B, C, and D. The signals A, B, C, and D indicate the pit distribution status of the four locations A, B, C, and D, respectively, of each track shown in FIG. 1.

Because the distribution of the recording pits is different, the intensity of each of the signals A, B, C, and D is also different. Then, the signals A, B, C, and D enter the adder/subtractor 20 (shown in FIG. 2). The adder/subtractor 20 performs the E=(A+D)−(B+C) calculation. After the E values pass the low pass filter 22, the E values enter the high threshold comparator 24 and the low pass threshold comparator 26 respectively.

When the light beam passes the upper recording pits 11 on the header 16, no recording pit is on the lower track. Therefore, the signals A and D are larger than the signals B and C, and the E value is higher than 0. The header indication signal CP1 is obtained as the E value passes through the high threshold comparator 24. Because the E value is lower than 0 after passing through the low threshold comparator 26, when the light beam passes the upper recording pits 11 on the header 16, the header indication signal CP2 will not be generated. On the other hand, when the light beam passes the lower recording pits 12 on the header 16, there are no recording pit on the upper track; therefore, the signal B and C are larger than the signals A and D, and the E value is lower than 0. The header indication signal CP2 is obtained as the E value passes through the low threshold comparator 26. Because the E value is lower than 0 after passing through the high threshold comparator 24, when the light beam passes the lower recording pits 12 on the header 16, the header indication signal CP1 will not be generated.

U.S. Patent Applied No. 2002/0039331 directly identifies whether the optical reading/reproducing device is reading the header 16 by determining whether the optical reading/reproducing device comprises the header indication signals CP1 and CP2. When the device receives the header indication signals CP1 or CP2, the present location is identified as the header 16.

The prior art merely takes the header indication signal CP1 or CP2 to be the signal for identifying the header. However, during the process of the optical reading/reproducing device reading a DVD-RAM disc, the light beam easily deviates from the middle of the track; thus, the header indication signal CP1 or CP2 often appears in locations that are non-headers. Therefore, the prior art is often unable to identify the header correctly, making discriminating error. The discriminating error further causes error when the optical reading/reproducing device reads DVD-RAM discs. Therefore, there is a need of a method and system thereof which is able to identify the header correctly and reduce the error when the optical reading/reproducing device reads DVD-RAM discs, thus further increasing the operating efficiency of the optical reading/reproducing device.

### SUMMARY OF THE INVENTION

An objective of the present invention is to provide an optical discriminating system and method for solving the problems of the prior arts.

Another objective of the present invention is to provide an optical discriminating system and method for correctly discriminating whether a reflected light beam is reflected from a plurality of headers of an optical storage medium.

In one embodiment according to the present invention, an optical discriminating system is used for discriminating whether a reflected light beam is from a plurality of headers of an optical storage medium. The optical discriminating system comprises a light beam detecting module and a signal detecting module.

When the reflected light beam reflects from the first embossed position of the header, a first header signal is generated. When the reflected light beam reflects from the second embossed position, a second header signal is generated. When the reflected light beam comprises address information, an address mark signal is generated. Furthermore, when the system continuously receives the first header signal the second header signal, and also the address mark signal at the same time, the system discriminates that the reflected light beam is reflected from one of the headers.

By using the first header signal, the second header signal, and the address mark signal at the same time to discriminate the header, the present invention can reduce the reading errors caused by discriminating errors, which are caused by the false first and second header signals of the header. By generating a mask signal, the present invention further masks the false first and second header signals, so as to reduce interference.

The advantage and spirit of the invention may be understood by the following recitations together with the appended drawings.

### BRIEF DESCRIPTION OF THE APPENDED DRAWINGS

FIG. 1 is a schematic diagram of a track of a conventional DVD-RAM disc.

FIG. 2 is a schematic diagram of the generating circuit of the header indication signal of a conventional DVD-RAM reading/reproducing device.

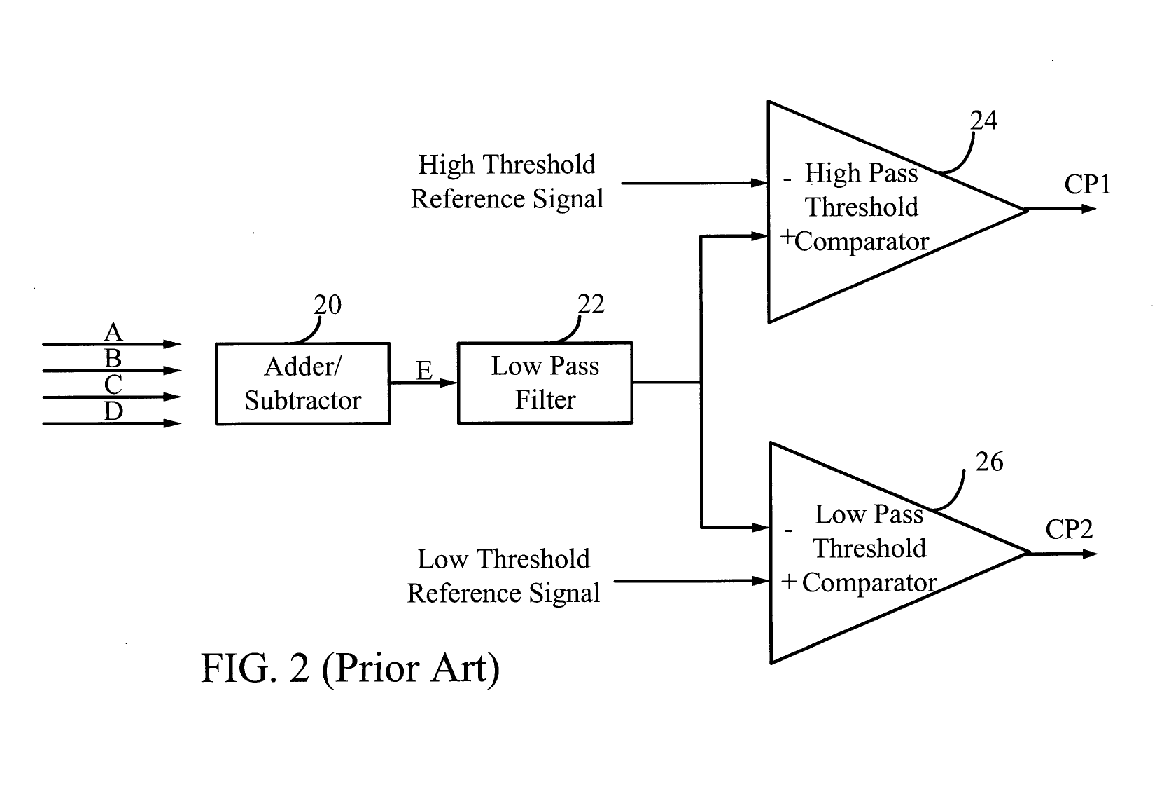

FIG. 3 is a function block diagram of an optical discriminating system according to the present invention.

FIG. 4 is a schematic diagram of the signal generation and the plurality of discriminating embodiments of the optical discriminating system shown in FIG. 3.

FIG. 5 is a flow chart of the optical discriminating method of the third embodiment shown in FIG. 4.

### DETAILED DESCRIPTION OF THE INVENTION

The present invention provides an optical discriminating system for discriminating whether a reflected light beam is from a header of an optical storage medium. The reflected light beam is shot from an optical reading/reproducing device and is reflected by the optical storage medium. The optical storage medium is a conventional optical disc, such as a disc of DVD-RAM. The optical reading/reproducing device can be a conventional DVD-RAM drive.

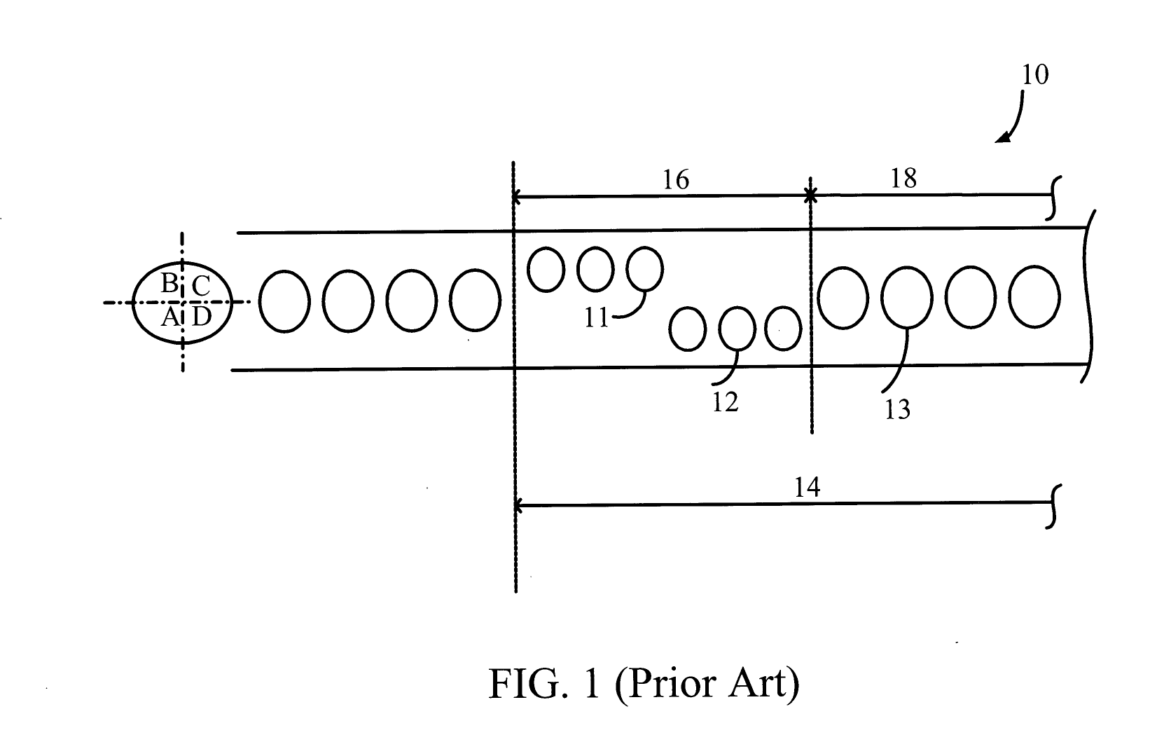

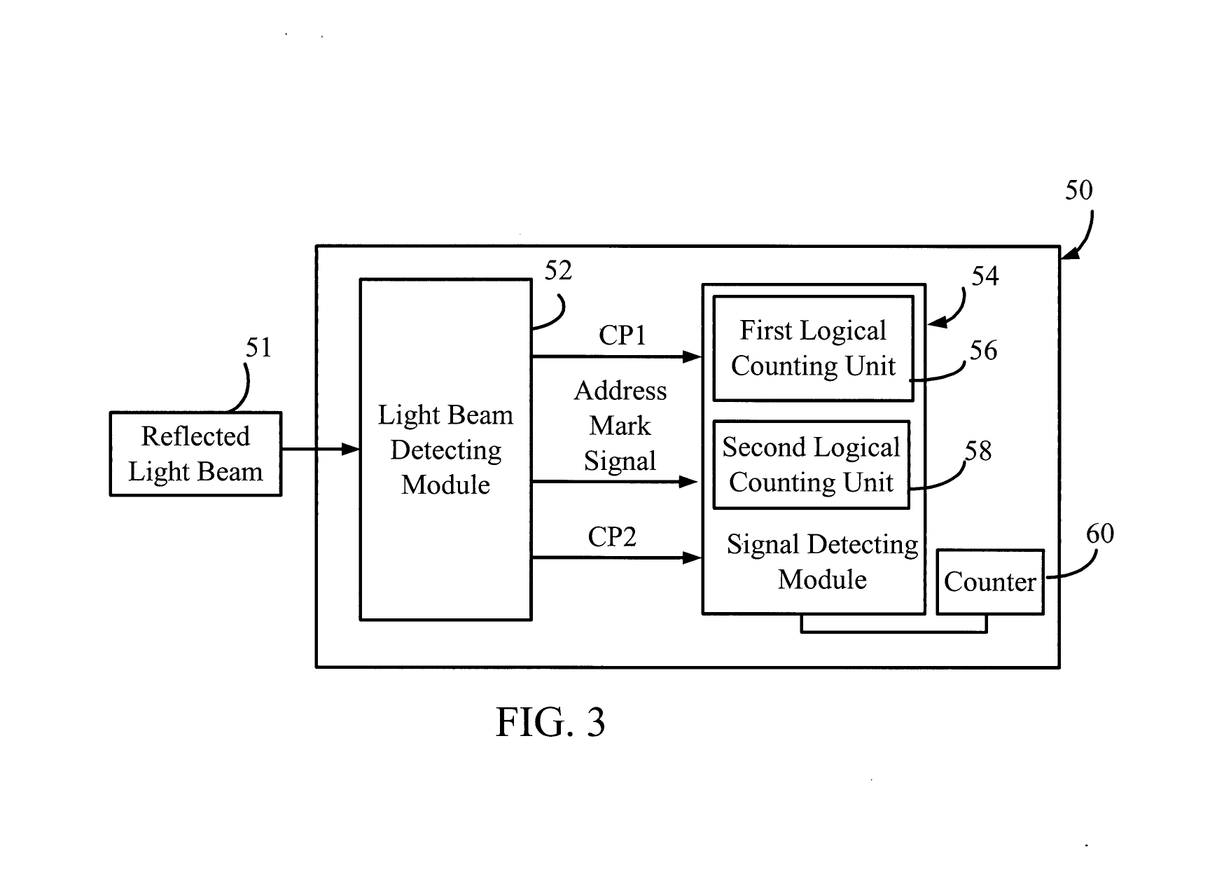

Referring to FIG. 3, FIG. 3 is a function block diagram of an optical discriminating system 50 according to the present invention. Also, referring to FIG. 1, the track 10 of the optical storage medium is used in this embodiment. The reflected light beam 51 is reflected from the track 10 of the optical storage medium. The headers of the optical storage medium are illustrated by the header 16 shown in FIG. 1. Each of the headers 16 comprises a first embossed position and a second embossed position for recording an address information. The first embossed position is the upper recording pits 11 of the headers 16 shown in FIG. 1. The second embossed position is the lower recording pits 12 of the headers 16 shown in FIG. 1. According to DVD-RAM specification, the address information can be the variable frequency oscillator field, the address mark field, the physical ID field or other signals referring to the above information in the headers 16.

As shown in FIG. 3, the optical discriminating system 50 comprises a light beam detecting module 52 and a signal detecting module 54. The light beam detecting module 52 is used for receiving the reflected light beam 51. When the reflected light beam 51 is reflected from the first embossed position, the light beam detecting module 52 generates a first header signal CP1. When the reflected light beam 51 is reflected from the second embossed position, the light beam detecting module generates a second header signal CP2. When the reflected light beam 51 comprises the address information, the light beam detecting module 52 generates an address mark signal.

The signal detecting module 54 is used for receiving the first header signal CP1, the second header signal CP2, and the address mark signal. The signal detecting module 54 comprises an initial state (IS) and a mask state (MS). The signal detecting module 54 controls which state itself should be at. When the signal detecting module 54 is at the initial state (IS), it receives all the first header signal CP1 and the second header signal CP2. When the signal detecting module 54 is at the mask state (MS), it generates a periodical mask signal to mask the first header signal CP1 and the second header signal CP2 received in the non-header.

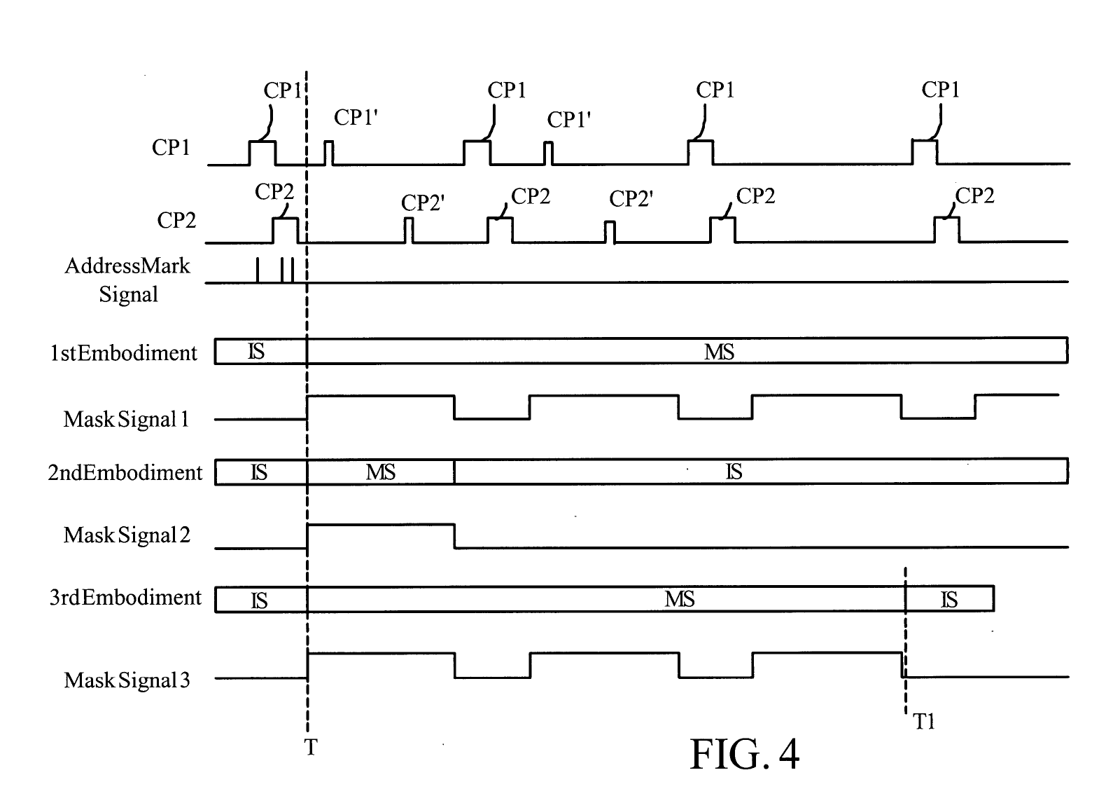

Referring to FIG. 4, FIG. 4 is a schematic diagram of the signal generation and several embodiments discriminated by the optical discriminating system 50 shown in FIG. 3. Because the optical storage medium comprises a plurality of sectors, and each sector comprises a header 16 and a recording area 18, when the light beam detecting module 52 reads each sector, it generates the first header signal CP1 and the second header signal CP2 periodically. However, when the optical reading/reproducing device reads the optical storage medium, the problem that the light beam deviates from the middle of the track often happens; thus, sometimes when the light beam detecting module 52 reads the recording area 18, the light beam detecting module 52 still generates the first header signal CP1 and the second header signal CP2. In this situation, the first and second header signals are the false first header signal CP1′ and second header signal CP2′ shown in FIG. 4.

When the optical reading/reproducing device starts to read the optical storage medium, the signal detecting module 54 is predetermined at the initial state (IS). When the signal detecting module 54 continuously receives the first header signal (CP1), the second header signal (CP2), and also the address mark signal at the same time, the signal detecting module 54 discriminates that the reflected light beam 51 is reflected from one of the headers. When the signal detecting module 54 discriminates that the reflected light beam 51 is reflected from the header, the signal detecting module 54 changes from the initial state (IS) to the mask state (MS). When the signal detecting module 54 is at the initial state (IS), it must continuously receive the first header signal CP1, the second header signal CP2, and also the address mark signal at the same time, in order to discriminate that the reflected light beam 51 is reflected from the header. When the signal detecting module 54 is at the mask state (MS), it generates a mask signal periodically to mask the received first and second header signal. Therefore, when the received first and second header signals are un-masked, the signal detecting module 54 discriminates that the reflected light beam is reflected from the header 16. The length of the mask signal can be set as the gap 14 between the neighboring headers (shown in FIG. 1). The gap 14 is equal to the length of each non-header 16 and also to the length of the recording area 18. In FIG. 4, the time when the signal detecting module 54 starts to change the state and send out the mask signal is represented by the time axis (T).

As shown in FIG. 3, the signal detecting module 54 further comprises a first logical counting unit 56 and a second logical counting unit 58. The first logical counting unit 56 is used for receiving the first header signal CP1 and the mask signal. The second logical counting unit 58 is used for receiving the second header signal CP2 and the mask signal. When the first logical counting unit 56 receives the first header signal CP1′ and the mask signal at the same time, the mask signal masks the first header signal CP1′. In the same way, when the second logical counting unit 58 receives the second header signal CP2′ and the mask signal at the same time, the mask signal masks the second header signal CP2′.

The present invention discriminates whether the reflected light beam is reflected from the header 16 by the address mark signal and further sends out the mask signal to mask the false first and second header signals, so as to reduce the chance of causing error when the optical reading/reproducing device reads the optical storage medium.

The optical discriminating system 50 further comprises a counter 60. When the signal detecting module 54 is at the mask state (MS), the counter 60 is used for counting the length of a mask period (MP) of the mask signal. In an embodiment of the present invention, the counter 60 starts to count from 0; when the counter counts to a first specific value, the mask period (MP) starts, and when the counter counts to a second specific value, the mask period (MP) ends. When the signal detecting module 54 receives the un-masked first or second header signal, the value of the counter 60 returns to 0. The gap between the first and second specific value can be the length of a recording area 18 of the optical storage medium.

In this paragraph, an example is used to illustrate the operating method of the counter 60. Conventionally, the counter 60 counts by bytes. When the counter 60 receives the first header signal CP1 and the second header signal CP2, the counter 60 starts to count from 0. When the counter 60 counts to the eighth byte of the recording area 18, the signal detecting module 54 sends out the mask signal, and the mask period (MP) starts. A recording area 18 of a conventional disc of DVD-RAM comprises 2567 bytes. When the counter 60 counts to the 2500th byte, the signal detecting module 54 ends the mask period (MP) and stops to send out the mask signal. When the counter 60 receives the un-masked first and second header signals again, the above steps are repeated.

In the following paragraphs, the optical discriminating method of the present invention is illustrated by three embodiments according to each signal shown in FIG. 4. The main difference between each embodiment is the difference of the setting conditions of the signal detecting module when starting and ending the mask state (MS).

According to the first embodiments shown in FIG. 4, because the length of the header 16 and the recording area 18 on the optical storage medium are fixed, after discriminating the first header 16 by the first header signal CP1, the second header signal CP2, and the address mark signal, the signal detecting module enters the mask state (MS). Whether the optical discriminating system 50 later receives the address mark signal again or not, the signal detecting module still remains at the mask state (MS). The counter 60 starts to count from 0 after discriminating the first header 16. Every time the counter 60 counts to a specific byte number, it indicates that the next header 16 is approaching, and the mask signal must be cleared. Therefore, the signal detecting module 54 periodically sends out the mask signal from the non-header 16 according to the counting result of the counter 60. Then, the first logical counting unit 56 and the second logical counting unit 58, according to the mask signal, mask the error CP1′ and CP2′ sent from the recording area 18. The time sequence which the signal detecting module 54 generates the mask signal is shown as the mask signal 1 in FIG. 4.

However, when the counting frequency of the counter 60 is unstable, or the first header 16 has an error when discriminating, the method of the 1st embodiment shown in FIG. 4 will affect the later discrimination of all the headers. The 2nd embodiment can avoid the problem of the 1st embodiment. According to the 2nd embodiment in FIG. 4, when the first mask period (MP) ends, the signal detecting module 54 returns to the initial state (IS) immediately. The signal detecting module 54 does not enter the mask state (MS) again until the first header signal CP1, the second header signal CP2, and the address mark signal are detected at the same time. After the signal detecting module 54 returns to the initial state (IS), if the signal detecting module 54 only detects the first header signal CP1 and the second header signal CP2, without the address mark signal, the signal detecting module 54 remains at the initial state (IS). The time sequence which the signal detecting module 54 generates the mask signal is shown as the mask signal 2 in FIG. 4.

Even though the 2nd embodiment shown in FIG. 4 can increase the discriminating accuracy to the header 16 when the optical reading/reproducing device reads the optical storage medium, the 2nd embodiment sometimes has problems also. Because when the optical reading/reproducing device reads the optical storage medium, the address mark signal will not be sent out sometimes. In the 2nd embodiment, near the header 16 which has not sent out the address mark signal yet, the optical reading/reproducing device may be affected by the false CP1′ and CP2′ and is unable discriminate the header 16 correctly.

The present invention provides another method in another embodiment to solve the problems of the 2nd embodiment. First, after entering the mask state (MS) the first time, the signal detecting module 54 remains at the mask state (MS) in some specific period. During the period, even though the signal detecting module 54 only receives the first header signal CP1 and the second header signal CP2, without the address mark signal, the signal detecting module 54 remains at the mask state (MS). When the specific period amount is exceeded, and the signal detecting module 54 still has not received the address mark signal after the mask period (MP) set by the specific period amount ends, the signal detecting module 54 returns to the initial state (IS). The signal detecting module 54 does not enter the mask state (MS) again until the signal detecting module 54 detects the first header signal CP1, the second header signal CP2, and the address mark signal again at the same time.

For example, referring to the 3rd embodiment in FIG. 4, the specific period amount of the signal detecting module 54 is assumed to be 2. After discriminating the first header 16, even though the signal detecting module 54 has not received the address mark signal of the second header 16, the signal detecting module still remains at the mask state (MS). However, after the second mask period (MP) ends, the signal detecting module 54 does not receive the address mark signal of the third header 16, then the signal detecting module 54 returns to the initial state (IS) after the third mask period (MP) ends. In FIG. 4, the time when the signal detecting module 54 returns to the initial state (IS) is represented by the time axis (T1). The signal detecting module 54 does not enter the next mask state (MS) until the signal detecting module 54 detects the first header signal CP1, the second header signal CP2, and the address mark signal again at the same time. The time sequence which the signal detecting module 54 generates the mask signal is shown as the mask signal 3 in FIG. 4.

According to the DVD-RAM specifications, the data reading error caused by missing the header 16 in the specific period amount can be corrected by the decoding procedures of the DVD drive. As the method described in the 1st embodiment in FIG. 3, sometimes too many error periods occur under unstable frequency and those errors exceed the correcting capacity that the decoding procedure of the DVD drive can handle, thus directly causing data decoding error. Unlike the 1st embodiment, according to the 3rd embodiment shown in FIG. 4, if the number of headers that have not sent out the address mark signal is less than the specific period amount, then the optical reading/reproducing device can discriminate the header 16 correctly. The 3rd embodiment shown in FIG. 4 not only avoids the problems of the 2nd embodiment but further increases the correctness when the optical reading/reproducing device discriminates the header 16. In order to put the 3rd embodiment into practice, the optical discriminating system 50 shown in FIG. 3 further comprises a counter (not shown in FIG. 3) for counting the specific period amount.

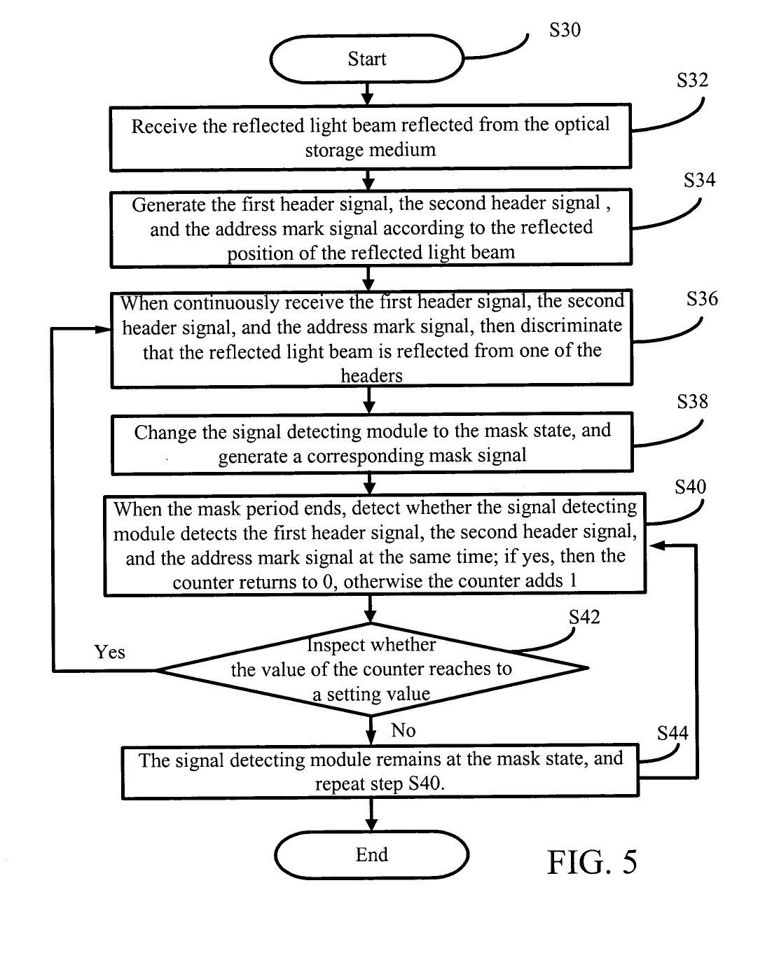

Referring to FIG. 5, FIG. 5 is a flow chart of the optical discriminating method of the third embodiment shown in FIG. 4. The method of how the optical discriminating system 50 applies the counter to put the 3rd embodiment shown in FIG. 4 into practice is described as follows. According to the present invention, the optical discriminating method comprises the following steps:
Step S30: start;
Step S32: receive the reflected light beam reflected from the optical storage medium;
Step S34: generate the first header signal CP1, the second header signal CP2, and the address mark signal according to the reflected position of the reflected light beam;
Step S36: when continuously receive the first header signal CP1, the second header signal CP2, and the address mark signal, then discriminate that the reflected light beam is reflected from one of the headers 16;
Step S38: change the signal detecting module 54 from the initial state (IS) to the mask state (MS), and generate a corresponding mask signal, the length of the mask signal is a mask period (MP);
Step S40: when the mask period (MP) ends, detect whether the signal detecting module 54 detects the first header signal CP1, the second header signal CP2, and the address mark signal at the same time; if yes, then the counter returns to 0, otherwise the counter adds 1;
Step S42: inspect whether the value of the counter reaches to a setting value (in this embodiment the value is 2); if yes, the signal detecting module 54 returns to the initial state (IS) and goes to step S36, otherwise go to step S40;
Step S44: the signal detecting module 54 remains at the mask state (MS), and repeat step S40.

The present invention provides an optical discriminating system and method for discriminating whether a reflected light beam is from a plurality of headers of an optical storage medium. The optical discriminating system comprises a light beam detecting module and a signal detecting module. When the reflected light beam is reflected from a first embossed position, a first header signal is generated. When the reflected light beam is reflected from a second embossed position, a second header signal is generated. When the reflected light beam comprises an address information, an address mark signal is generated. When continuously receiving the first header signal, the second header signal, and also the address mark signal at the same time, then the reflected light beam is discriminated to be reflected from one of the headers.

By using the first header signal, the second header signal, and the address mark signal at the same time to discriminate the header, the present invention can reduce the reading errors caused by discriminating errors, which are caused by the false first and second header signals of the header. By generating the mask signal, the present invention further masks the false first and second header signal, so as to reduce interference.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. An optical discriminating system for discriminating whether a reflected light beam is from a plurality of headers of an optical storage medium, the reflected light beam being shot from an optical reading/reproducing device and being reflected by the optical storage medium, each of the headers comprising a first embossed position and a second embossed position for recording an address information, the optical discriminating system comprising:
a light beam detecting module for receiving the reflected light beam, wherein
when the reflected light beam is reflected from the first embossed position, a first header signal is generated;
when the reflected light beam is reflected from the second embossed position, a second header signal is generated; and
when the reflected light beam comprises the address information, an address mark signal is generated; and
a signal detecting module for receiving the first header signal, the second header signal, and the address mark signal;
wherein when the signal detecting module continuously receives the first header signal and the second header signal, and also receives the address mark signal at the same time, then the signal detecting module discriminates that the reflected light beam is reflected from one of the plurality of headers.

2. The optical discriminating system of claim 1, wherein the signal detecting module comprises an initial state and a mask state, the signal detecting module is predetermined at the initial state, when the signal detecting module continuously receives the first header signal and the second header signal, and also receives the address mark signal at the same time, then the signal detecting module discriminates that the reflected light beam is reflected from one of the headers, then the signal detecting module changes from the initial state to the mask state.

3. The optical discriminating system of claim 2, wherein when the signal detecting module is at the mask state, a mask signal is generated for masking the following received first and second header signal.

4. The optical discriminating system of claim 3, further comprising a counter for counting the length of a mask period of the mask signal.

5. The optical discriminating system of claim 4, wherein the length of the mask period is counted by bytes, the counter starts to count from 0, when the counter counts to a first specific value, then the mask period starts, and when the counter counts to a second specific value, then the mask period ends.

6. The optical discriminating system of claim 5, wherein the gap between the first and second specific value is the length between each of the headers.

7. The optical discriminating system of claim 5, wherein the signal detecting module at the mask state periodically sends out the mask signal.

8. The optical discriminating system of claim 5, wherein when the signal detecting module continuously receives the first header signal and the second header signal, and also receives the address mark signal at the same time, then the counter is reset to a specific value.

9. The optical discriminating system of claim 5, wherein when the mask period ends, the signal detecting module changes to the initial state.

10. The optical discriminating system of claim 5, wherein after the mask period ended, if the signal detecting module does not receive the address mark signal, then the signal detecting module remains at the mask state.

11. The optical discriminating system of claim 10, wherein the signal detecting module remains at the mask state in a specific period amount, when exceeding the specific period amount and still receiving none address mark signal, then the signal detecting module returns to the initial state.

12. The optical discriminating system of claim 11, further comprising a counter for counting the specific period amount.

13. The optical discriminating system of claim 3, wherein the signal detecting module further comprises a first logical counting unit for receiving the first header signal and the mask signal, and when receiving the first header signal and the mask signal at the same time, then masking the first header signal.

14. The optical discriminating system of claim 3, wherein the signal detecting module further comprises a second logical counting unit for receiving the second header signal and the mask signal, and when receiving the second header signal and the mask signal at the same time, then masking the second header signal.

15. An optical discriminating method for discriminating whether a reflected light beam is from a plurality of headers of an optical storage medium, the reflected light beam being shot from an optical reading/reproducing device and being reflected by the optical storage medium, each of the headers comprising a first embossed position and a second embossed position for recording an address information, the optical discriminating method comprising the following steps:
receiving the reflected light beam reflected from the optical storage medium;
when the reflected light beam reflects from the first embossed position, generating a first header signal;
when the reflected light beam reflects from the second embossed position, generating a second header signal;
when the reflected light beam comprises the address information, generating an address mark signal; and
when continuously receiving the first header signal and the second header signal, and also receiving the address mark signal at the same time, then discriminating that the reflected light beam is reflected from one of the headers.

16. The optical discriminating method of claim 15, further comprising a signal detecting module, wherein the signal detecting module comprises an initial state and a mask state, the signal detecting module is predetermined at the initial state, when the signal detecting module continuously receives the first header signal and the second header signal, and also receives the address mark signal at the same time, then discriminates that the reflected light beam is reflected from one of the headers, then the signal detecting module changes from the initial state to the mask state.

17. The optical discriminating method of claim 16, wherein when the signal detecting module is at the mask state, a mask signal is generated for masking the received first and second header signal.

18. The optical discriminating method of claim 17, wherein when the signal detecting module receives the first header signal and the mask signal at the same time, the mask signal masks the first header signal; and wherein when the signal detecting module receives the second header signal and the mask signal at the same time, the mask signal masks the second header signal.

19. The optical discriminating method of claim 17, wherein the mask signal is active in a mask period.

20. The optical discriminating method of claim 17, wherein the signal detecting module at the mask state periodically sends out the mask signal.

21. The optical discriminating method of claim 19, wherein when the mask period ends, the signal detecting module changes to the initial state.

22. The optical discriminating method of claim 19, wherein after the mask period ends, if the signal detecting module does not receive the address mark signal, then the signal detecting module remains the mask state.

23. The optical discriminating method of claim 22, wherein the signal detecting module remains the mask state in a number of specific periods, when exceeding the number of specific periods and still receiving none address mark signal, then the signal detecting module returns to the initial state.
